(19) United States
(12) Patent Application Publication
(10) Pub. No.: US 2022/0182740 A1
(43) Pub. Date: Jun. 9, 2022

(54) INFORMATION PROCESSING APPARATUS, INFORMATION PROCESSING METHOD, AND COMMUNICATION SYSTEM

(71) Applicant: SONY GROUP CORPORATION, TOKYO (JP)

(72) Inventor: KAZUAKI TOBA, TOKYO (JP)

(21) Appl. No.: 17/438,361

(22) PCT Filed: Mar. 4, 2020
(86) PCT No.: PCT/JP2020/009029

§ 371 Date: Sep. 10, 2021

(30) Foreign Application Priority Data
Mar. 20, 2019 (JP) 2019-052287

(51) Int. Cl. H04Q 11/00

(52) U.S. Cl. CPC H04Q 11/0003

(57) ABSTRACT

To make it possible to satisfactorily perform a switching of an optical signal. An optical switch and a controller are included. The optical switch is situated between optical communication lines of a specified number of systems situated on an input side, and optical communication lines of a specified number of systems situated on an output side. The controller acquires connection-destination switching request information from an electric communication line, and controls, on the basis of the connection-destination switching request information, a connection established, in the optical switch, between the optical communication line on the input side and the optical communication line on the output side. The connection-destination switching request information includes, for example, connection destination information and time information that indicates a switching timing.

### TECHNICAL FIELD

The present technology relates to an information processing apparatus, an information processing method, and a communication system, and in particular to, for example, an information processing apparatus used to satisfactorily perform a switching of an optical signal.

### BACKGROUND ART

For example, Patent Literature 1 discloses a technology used to split an optical signal and to perform a switching of one optical signal on the basis of switching information obtained by converting the other optical signal into an electric signal. This technology makes it possible to perform a switching of an optical signal with no change, but it is necessary that a switching section include a photoelectric conversion circuit in order to acquire switching information.

In general, the photoelectric conversion circuit is a group of high-speed analog circuits that includes a photodetector (PD) that is an optical signal receiving section, a transimpedance amplifier (TIA) that performs a current-voltage conversion on a reception signal and amplifies the signal, and a clock and data recovery circuit (CDR) that extracts a clock component from a reception signal and samples data.

It may be difficult to manufacture this group of high-speed analog circuits using a normal complementary metal-oxide-semiconductor (CMOS). Further, it is necessary that the group of high-speed analog circuits include an expensive and complex dedicated component, and this results in heavy burden.

### CITATION LIST

### Patent Literature

Patent Literature 1: Japanese Patent Application Laid-open No. 2004-032469

### DISCLOSURE OF INVENTION

### Technical Problem

It is an object of the present technology to makes it possible to satisfactorily perform a switching of an optical signal.

### Solution to Problem

A concept of the present technology provides an information processing apparatus that includes an optical signal output section that outputs an optical signal to an optical communication line, and an electric signal output section that outputs connection-destination switching request information regarding the optical communication line to an electric communication line.

In the present technology, an optical signal is output to an optical communication line by the optical signal output section. Further, connection-destination switching request information regarding an optical signal is output to an electric communication line by the electric signal output section. For example, the optical communication line includes an optical fiber, the electric communication line includes an electric wire, and the optical communication line and the electric communication line are provided in a single cable.

As described above, in the present technology, connection-destination switching request information regarding an optical signal is output to an electric communication line. This enables the switcher performing a switching of an optical signal to obtain switching information without including a photoelectric conversion circuit. This makes it possible to easily manufacture the switcher at low cost.

Note that, in the present technology, for example, the connection-destination switching request information may include connection destination information. This makes it possible to switch to any connection destination. Further, in the present technology, for example, the connection-destination switching request information may include time information that indicates a switching timing. This makes it possible to switch the connection destination at any timing.

Further, in the present technology, for example, the optical signal output section may output an optical signal to each of the optical communication lines of a plurality of channels, and the electric signal output section may output, to the electric communication line, the connection-destination switching request information regarding the optical communication line of one of the plurality of channels. This makes it possible to perform switching only with respect to some of the destinations, and not with respect to all of the plurality of channels.

Further, another concept of the present technology provides an information processing apparatus that includes an optical signal input section to which an optical signal coming from an optical communication line is input, and an electric signal output section that outputs connection-destination switching request information regarding the optical communication line to an electric communication line.

In the present technology, an optical signal coming from an optical communication line is input to the optical signal input section. Further, connection-destination switching request information regarding an optical signal is output to an electric communication line by the electric signal output section. For example, the optical communication line includes an optical fiber, the electric communication line includes an electric wire, and the optical communication line and the electric communication line are provided in a single cable.

As described above, in the present technology, connection-destination switching request information regarding an optical signal is output to an electric communication line. This enables the switcher performing a switching of an optical signal to obtain switching information without including a photoelectric conversion circuit. This makes it possible to easily manufacture the switcher at low cost.

Note that, in the present technology, for example, the connection-destination switching request information may include connection destination information. This makes it possible to switch to any connection destination. Further, in the present technology, for example, the connection-destination switching request information may include time information that indicates a switching timing. This makes it possible to switch the connection destination at any timing.

Further, in the present technology, for example, an optical signal from each of the optical communication lines of a plurality of channels may be input to the optical signal input section, and the electric signal output section may output, to the electric communication line, the connection-destination switching request information regarding the optical communication line of one of the plurality of channels. This makes it possible to perform switching only with respect to some of the destinations, and not with respect to all of the plurality of channels.

Further, another concept of the present technology provides an information processing apparatus that includes an optical switch that is situated between optical communication lines of a specified number of systems situated on an input side, and optical communication lines of a specified number of systems situated on an output side; and a controller that acquires connection-destination switching request information from an electric communication line, and controls, on the basis of the connection-destination switching request information, a connection established, in the optical switch, between the optical communication line on the input side and the optical communication line on the output side.

In the present technology, the optical switch being situated between optical communication lines of a specified number of systems situated on an input side, and optical communication lines of a specified number of systems situated on an output side, is included. Further, connection-destination switching request information is acquired by the controller from an electric communication line, and a connection established, in the optical switch, between the optical communication line on the input side and the optical communication line on the output side is controlled by the controller on the basis of the connection-destination switching request information.

As described above, in the present technology, a connection established, in the optical switch, between the optical communication line on the input side and the optical communication line on the output side is controlled on the basis of connection-destination switching request information acquired from the electric communication line. Thus, there is no need for a photoelectric conversion circuit. This makes it possible to easily perform manufacturing at low cost.

Note that, in the present technology, for example, the connection-destination switching request information may include connection destination information. This makes it possible to switch to any connection destination. Further, in the present technology, for example, the connection-destination switching request information may include time information that indicates a switching timing. This makes it possible to switch the connection destination at any timing.

Further, in the present technology, for example, on the basis of the connection-destination switching request information, the controller may control a connection established, in the optical switch, between the optical communication line of one of a plurality of channels situated on the input side, and the optical communication line of one of a plurality of channels situated on the output side. This makes it possible to perform switching only with respect to some of the destinations, and not with respect to all of the plurality of channels.

Furthermore, in the present technology, for example, a connection section through which electric communication lines respectively corresponding to the optical communication lines of the specified number of systems situated on the input side, and electric communication lines respectively corresponding to the optical communication lines of the specified number of systems situated on the output side are all mutually connected, may be further included. Consequently, for example, connection-destination switching request information transmitted from a certain external apparatus can be relayed to another external apparatus.

Further, another concept of the present technology provides a communication system that includes a specified number of output apparatuses (information processing apparatuses); a specified number of input apparatuses (information processing apparatuses); and a switcher (an information processing apparatus) that is situated between the specified number of output apparatuses and the specified number of input apparatuses, the communication system further including an optical communication line and an electric communication line between each of the specified number of output apparatuses and the switcher, the communication system further including an optical communication line and an electric communication line between each of the specified number of input apparatuses and the switcher, the switcher connecting a specified one of the optical communication lines on an input side to a specified one of the optical communication lines on an output side, on the basis of connection-destination switching request information acquired from the electric communication line.

### BRIEF DESCRIPTION OF DRAWINGS

FIG. 1 is a block diagram illustrating an example of a configuration of a communication system.

FIG. 2 illustrates an example of a configuration of a cable.

FIG. 3 is a block diagram illustrating an example of a configuration of a video output apparatus.

FIG. 4 is a block diagram illustrating an example of a configuration of a display apparatus.

FIG. 5 is a block diagram illustrating an example of a configuration of a switcher.

FIG. 6 illustrates an example of a configuration of an optical switch.

FIG. 7 illustrates an example of a control sequence.

FIG. 8 illustrates another example of the control sequence.

FIG. 9 is a diagram for describing an example of a switching control performed when a plurality of independent optical communication channels are provided.

FIG. 10 is a diagram for describing the case in which a signal has a packet structure.

### MODE(S) FOR CARRYING OUT THE INVENTION

Embodiments for carrying out the present technology (hereinafter referred to as “embodiments”) will now be described below. Note that the description is made in the following order.
1. Embodiments
2. Modifications

### 1. EMBODIMENTS

### Description of Present Technology

The achievement of a higher resolution of a digital video results in the necessity of an interface used to transmit the higher-resolution digital video accommodating a broader band.

For example, a 4K video and an 8K video have been proposed in the past. For example, a 4K video having a resolution 4 times higher than the resolution of a current full high-definition (FHD) video, and an 8K video having a resolution 16 times higher than the resolution of the current FHD video have been proposed.

Here, the FHD video is generally a video with a horizontal resolution of 1920 pixels and a vertical resolution of 1080 lines, where the refresh rate is 60 Hz. The 4K video is a video with a vertical resolution of 3840 pixels and a vertical resolution of 2160 lines, where the refresh rate is 60 Hz. Further, the 8K video is a video with a vertical resolution of 7680 pixels and a vertical resolution of 4320 lines, where the refresh rate is 60 Hz.

Further, an adoption of a refresh rate of 120 Hz that improves the characteristics of a moving image, and an expansion of a bit width of a signal used to represent each pixel from 8 bits to 12 bits in order to improve the color reproducibility and a brightness-representation performance, have also been proposed in the past.

Thus, there has been a rapid increase in an amount of data of a digital video in recent years, and there is a need for transmission capabilities in excess of 140 gigabits per second in order to transmit the data of a digital video. With respect to an interface used to transmit data using an electric signal, it has become difficult to regenerate a signal on the reception side due to a high-frequency signal component being degraded at a portion of a cable of the interface. This results in the difficulty in further speeding up.

In a high-speed Ethernet, transmission of 100 gigabits or more per second has been primarily applied to a base station and a data center, and an interface using an optical communication is used. In the interface using an optical communication, a high-speed electric signal is converted into an optical signal, the optical signal is transmitted through an optical fiber in a communication channel, and the optical signal is converted into an electric signal again on the reception side. Accordingly, an electric signal is communicated.

A signal is significantly less degraded in a transmission path in an optical fiber, and thus the optical fiber makes it possible to stably transmit a broadband digital signal over a relatively long distance. However, it is necessary that a circuit used to perform an electrical-optical signal conversion, and a circuit used to perform an optical-electrical signal conversion be additionally respectively provided to a transmission section and a reception section that are included in an interface using an electric signal.

Further, the following method is generally performed in an interface using an optical communication when the route of the interface is selected and changed. A received optical communication signal is converted into an electric signal, the electric signal is decoded to acquire information regarding switching, the route is selected and changed on the basis of the information, an electrical-optical signal conversion is performed on the received signal again, and thus an optical signal obtained by the conversion is output to a route after the selection and change.

In this case, a switching section does not have to understand all of the details of communication, such as all of the video data in a transmission of a digital video signal, and it is sufficient if the switching section only knows information regarding a destination of a signal. However, the necessity of providing the above-described circuit used to perform an optical-electrical signal conversion, and the above-described circuit used to perform an electrical-optical signal conversion results in heavy burden.

In the present technology, at least one communication channel for an electric signal is provided to an optical communication interface, and only destination information is separately communicated using the communication channel for an electric signal. Accordingly, the route of the optical communication interface is selected and changed without a circuit used to perform an optical-electrical signal conversion.

[Configuration of Communication System]

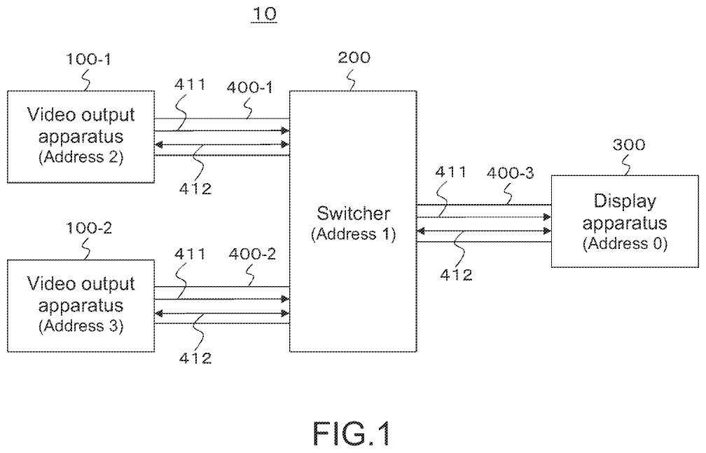

FIG. 1 illustrates an example of a configuration of a communication system 10. The communication system 10 includes video output apparatuses 100-1 and 100-2, a switcher 200, and a display apparatus 300. The display apparatus 300 is an apparatus of an address 0, the switcher 200 is an apparatus of an address 1, the video output apparatus 100-1 is an apparatus of an address 2, and the video output apparatus 100-2 is an apparatus of an address 3.

Each of the video output apparatuses 100-1 and 100-2 is an apparatus that transmits a video signal, and examples of the video output apparatuses 100-1 and 100-2 include AV sources such as a personal computer, a game machine, a disc player, a set-top box, a digital camera, and a cellular phone. The display apparatus 300 is an apparatus that receives a video signal and performs an image display, and examples of the display apparatus 300 include a television set and a projector. The switcher 200 selectively transmits, to the display apparatus 300, a video signal received from the video output apparatus 100-1, 100-2.

The video output apparatus 100-1 and the switcher 200 are connected to each other through a cable 400-1. Further, the video output apparatus 100-2 and the switcher 200 are connected to each other through a cable 400-2. Furthermore, the switcher 200 and the display apparatus 300 are connected to each other through a cable 400-3. The cables 400-1, 400-2, and 400-3 each include an optical fiber 411 for an optical communication, and an electric wire 412 for an electric communication, the optical fiber 411 being included in an optical communication line, the electric wire 412 being included in an electric communication line.

Here, a video signal is transmitted through the optical fiber 411 in the form of an optical signal. Connection-destination switching request information regarding the video signal is transmitted through the electric wire 412. In addition to being supplied to the switcher 200 from the video output apparatus 100-1, 100-2, the connection-destination switching request information may also be supplied to the switcher 200 from the display apparatus 300.

The video output apparatuses 100-1 and 100-2, the switcher 200, and the display apparatus 300 each have clock information (a clock section), in which the times of the respective apparatuses are synchronized with one another by, for example, acquiring time information using, for example, an Internet connection.

The connection-destination switching request information supplied from the video output apparatus 100-1, 100-2 to the switcher 200 includes, as connection destination information, information regarding an address of the display apparatus 300 in addition to information regarding an address of the video output apparatus 100-1, 100-2. In the present embodiment, the connection-destination switching request information further includes time information that indicates a switching timing. Consequently, the connection destination is switched by the switcher 200 such that an optical signal output from each of the optical fibers 411 of the cables 400-1 and 400-2 respectively connected to the video output apparatuses 100-1 and 100-2 is input, at the switching timing, to the optical fiber 411 of the cable 400-3 connected to the display apparatus 300.

Further, the connection-destination switching request information supplied to the switcher 200 from the display apparatus 300 includes, as connection destination information, information regarding the address of the video output apparatus 100-1 or 100-2 in addition to information regarding the address of the display apparatus 300. In the present embodiment, the connection-destination switching request information further includes time information that indicates a switching timing. Consequently, the connection destination is switched by the switcher 200 such that an optical signal output from the optical fiber 411 of the cable 400-1 connected to the video output apparatus 100-1 or the optical fiber 411 of the cable 400-2 connected to the video output apparatus 100-2 is input, at the switching timing, to the optical fiber 411 of the cable 400-3 connected to the display apparatus 300.

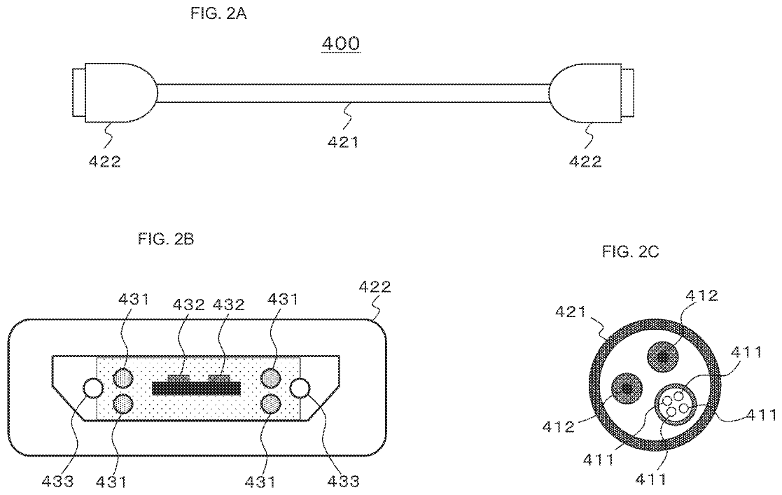

FIG. 2 illustrates an example of a configuration of a cable 400 (400-1, 400-2, 400-3). (a) of FIG. 2 illustrates the entirety of the cable 400. The cable 400 includes a cable portion 421 and plug portions 422 that are respectively provided at two ends of the cable portion 421. The plug portion 422 fits a receptacle portion included in a device (the video output apparatus 100-1, 100-2, the display apparatus 300), and communication is performed through terminals of the plug portion 422 and the receptacle portion that are connected to each other.

(b) of FIG. 2 illustrates an example of a terminal portion of the plug portion 422. The terminal portion includes an optical communication terminal 431 and an electric communication terminal 432, and may include a positioning pin 433 in order to ensure the accuracy in alignment of the optical communication terminal 431. The optical communication terminal 431 may adopt a physical contact (PC) approach in which optical fibers are connected by being brought into contact with each other, or a collimating approach in which light is expanded into collimated light using a lens to perform a non-contact coupling. In the illustrated example, four optical communication terminals 431 and two electric communication terminals 432 are provided. However, the number of optical communication terminals 431 and the number of electric communication terminals 432 are not limited to those numbers, and it is sufficient if there are at least one optical communication terminal 431 and at least one electric communication terminal 432. (c) of FIG. 2 illustrates an internal structure of the cable portion 421. The optical fiber 411 for an optical communication and the electric wire 412 for an electric communication coexist in the cable portion 421.

It is assumed that the optical communication terminal 431 has capabilities sufficient to transmit a broadband video signal, such as capabilities of transmitting from 150 to 200 gigabits per second, as in the example described above. On the other hand, it is sufficient if the electric communication terminal 432 has capabilities sufficient to communicate, for example, a control signal necessary to be shared by devices, such as capabilities of transmitting from about 100 megabits to about 1 gigabit per second. A signal is less degraded in a transmission path in the optical fiber 411, and the bandwidth of an electric communication is not so high. Thus, the configuration described above makes it possible to generally use a long cable up to about 100 m

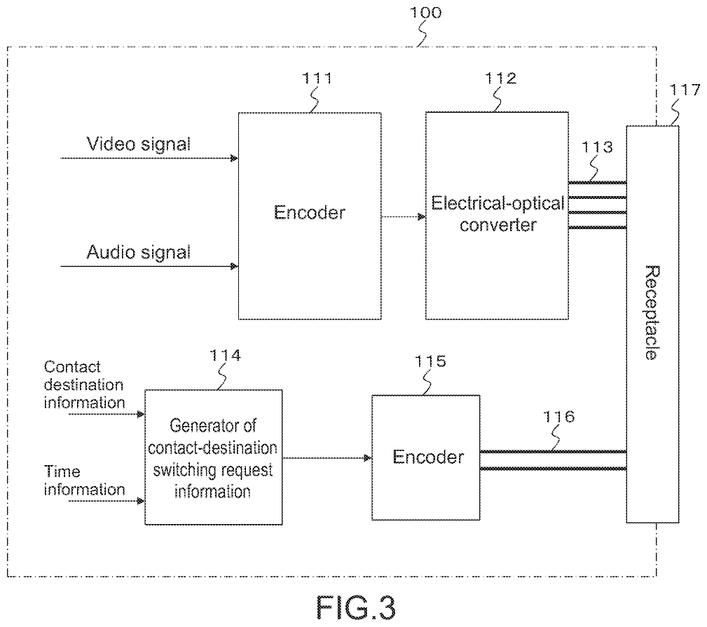

FIG. 3 illustrates an example of a configuration of a video output apparatus 100 (100-1, 100-2). The video output apparatus 100 includes an encoder 111, an electrical-optical converter 112, an optical fiber 113, a generator 114 of contact-destination switching request information, an encoder 115, electric wiring 116, and a receptacle 117.

A video signal and an audio signal associated with the video signal are input to the encoder 111. The encode 111 converts the video signal and the audio signal into a format suitable for transmission, and adds an error correction code to the signals, as necessary. Then, the encode 111 performs, for example, encoding on the signals to remove a DC component, and transmits the signals to the electrical-optical converter 112. The electrical-optical converter 112 converts the output signal of the encoder 111 from an electric signal to an optical signal, and transmits the optical signal to an optical communication terminal of the receptacle 117 through the optical fiber 113.

Further, connection destination information indicated by a user or a system, and time information indicating a switching timing are input to the generator 114 of contact-destination switching request information. As described above, the time information is generated on the basis of clock information in which the time is synchronized in each apparatus. The generator 114 of contact-destination switching request information generates connection-destination switching request information that includes the contact destination information and the time information, and transmits the generated connection-destination switching request information to the encoder 115. The encoder 115 converts the connection-destination switching request information into a format suitable for transmission, and then transmits the connection-destination switching request information to an electric communication terminal of the receptacle 117 through the electric wiring 116.

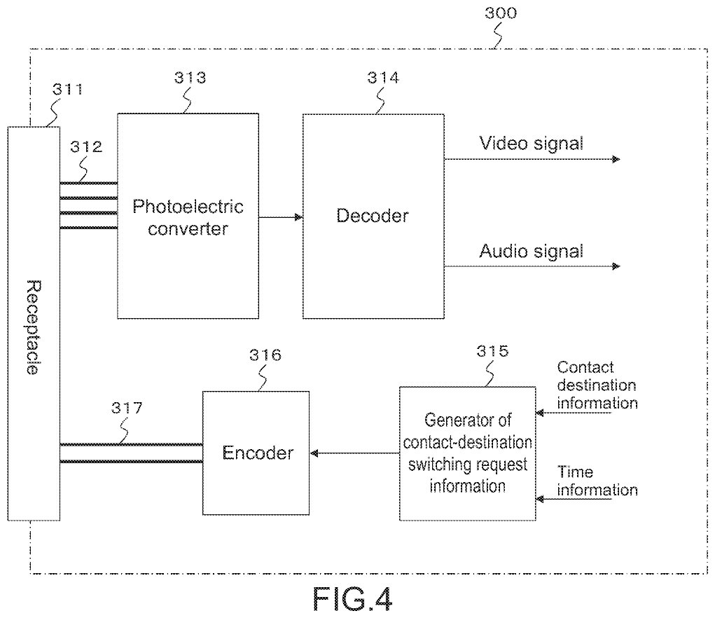

FIG. 4 illustrates an example of a configuration of the display apparatus 300. The display apparatus 300 includes a receptacle 311, an optical fiber 312, a photoelectric converter 313, a decoder 314, a generator 315 of contact-destination switching request information, an encoder 316, and electric wiring 317.

An optical signal transmitted to an optical communication terminal of the receptacle 311 is transmitted to the photoelectric converter 313 through the optical fiber 312. The photoelectric converter 313 converts the optical signal into an electric signal, and transmits the electric signal to the decoder 314. The decoder 314 performs decoding processing on the electric signal to obtain a video signal and an audio signal associated with the video signal. The video signal is supplied to an image display section such as a display, and the audio signal is supplied to a sound output section such as a speaker, although an illustration thereof is omitted.

Further, connection destination information indicated by a user or a system, and time information indicating a switching timing are input to the generator 315 of contact-destination switching request information. As described above, the time information is generated on the basis of clock information in which the time is synchronized in each apparatus. The generator 315 of contact-destination switching request information generates connection-destination switching request information that includes the contact-destination information and the time information, and transmits the generated connection-destination switching request information to the encoder 316. The encoder 316 converts the connection-destination switching request information into a format suitable for transmission, and then transmits the connection-destination switching request information to an electric communication terminal of the receptacle 311 through the electric wiring 317.

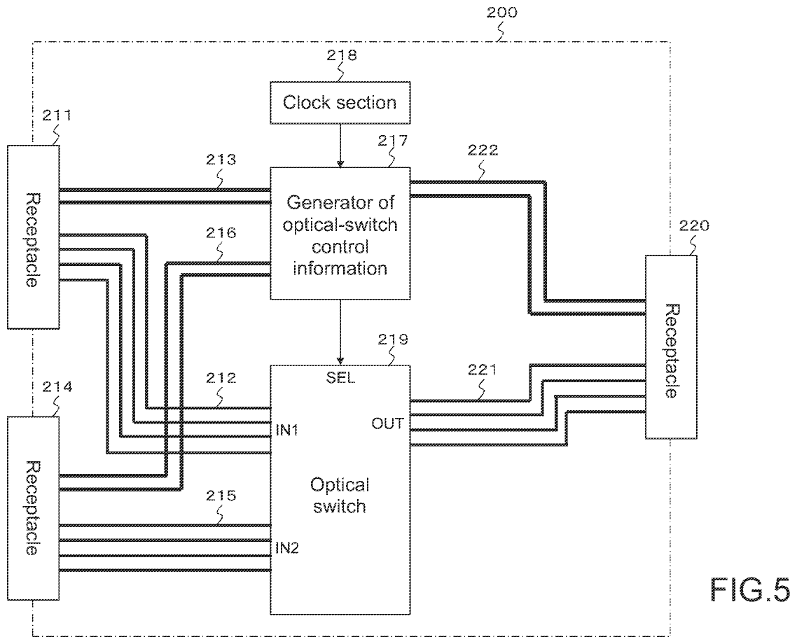

FIG. 5 illustrates an example of a configuration of the switcher 200. The switcher 200 includes a receptacle 211, an optical fiber 212, electric wiring 213, a receptacle 214, an optical fiber 215, electric wiring 216, a generator 217 of optical-switch control information, a clock section 218, an optical switch 219, a receptacle 220, an optical fiber 221, and electric wiring 222.

The video output apparatuses 100-1 and 100-2 are respectively connected to the receptacles 211 and 214 through the respective cables 400-1 and 400-2. The display apparatus 300 is connected to the receptacle 220 through the cable 400-3.

An optical communication terminal of the receptacle 211 is connected to an input section IN1 of the optical switch 219 through the optical fiber 212. Further, an electric communication terminal of the receptacle 211 is connected to the generator 217 of optical-switch control information through the electric wiring 213.

An optical communication terminal of the receptacle 214 is connected to an input section IN2 of the optical switch 219 through the optical fiber 215. Further, an electric communication terminal of the receptacle 214 is connected to the generator 217 of optical-switch control information through the electric wiring 216.

An optical communication terminal of the receptacle 220 is connected to an output section OUT of the optical switch 219 through the optical fiber 221. Further, an electric communication terminal of the receptacle 220 is connected to the generator 217 of optical-switch control information through the electric wiring 222.

The electric wiring 213, the electric wiring 216 and the electric wiring 222 are mutually connected through the generator 217 of optical-switch control information. Accordingly, connection-destination switching request information output from one of the video output apparatus 100-1, the video output apparatus 100-2, and the display apparatus 300 can be transmitted to all of the other apparatuses to be recognized by all of the other apparatuses.

On the basis of connection-destination switching request information, the generator 217 of optical-switch control information generates control information used to control the optical switch 219. As described above, the connection-destination switching request information includes connection destination information and time information that indicates a switching timing. The generator 217 of optical-switch control information transmits optical-switch control information to a control-information input section SEL of the optical switch 219 when the time indicated by the clock section 218 is the time of the switching timing. Consequently, the optical switch 219 is controlled such that an optical fiber of an apparatus that outputs connection-destination switching request information, and an optical fiber of a connection-destination apparatus are connected to each other.

Note that there is a possibility that the connection-destination switching request information will not include connection destination information when the connection destination is determined in advance. For example, when the connection-destination switching request information is output from the video output apparatus 100-1 or 100-2, the display apparatus 300 is a sole connection destination. Thus, it is not a problem if the connection destination information is not included. On the other hand, when the connection-destination switching request information is output from the display apparatus 300, the connection destination can be selected from two options that are the video output apparatus 100-1 and the video output apparatus 100-2. Thus, there is a need for the connection destination information.

Further, there is a possibility that the connection-destination switching request information will not include time information that indicates a switching timing when a switching of connection is performed immediately. In this case, the generator 217 of optical-switch control information immediately transmits, to the control-information input section SEL of the optical switch 219, optical-switch control information generated on the basis of the connection-destination switching request information without referring to the time indicated by the clock section 218.

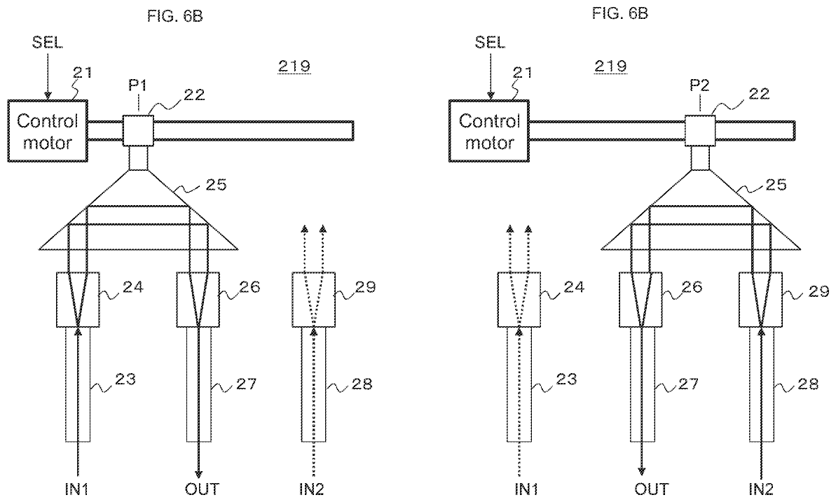

FIG. 6 illustrates an example of a configuration of the optical switch 219. The optical switch 219 internally includes a mechanism that is capable of switching an optical signal output to the output section OUT to an optical signal input to the input section IN1 or the input section IN2 by a control motor 21 being controlled using optical-switch control information input to the control-information input section SEL.

(a) of FIG. 6 illustrates a state in which switching is performed such that an optical signal input to the input section IN1 is output from the output section OUT. In this case, an actuator 22 used to fix a total reflection prism 25 is controlled to be moved to a position P1, and the optical signal input to the input section IN1 is output from the output section OUT through an optical fiber 23, a lens 24, the total reflection prism 25, a lens 26, and an optical fiber 27.

(b) of FIG. 6 illustrates a state in which switching is performed such that an optical signal input to the input section IN2 is output from the output section OUT. In this case, the actuator 22 used to fix the total reflection prism 25 is controlled to be moved to a position P2, and the optical signal input to the input section IN2 is output from the output section OUT through an optical fiber 28, a lens 29, the total reflection prism 25, the lens 26, and the optical fiber 27.

Note that the example in which the optical switch 219 is provided by controlling the position of the total reflection prism 25 has been described above. However, the mechanism of an optical switch is not limited to this example. For example, the mechanism of an optical switch may be provided by a mirror being accurately controlled by a microelectromechanical system (MEMS), or may be provided by using a switch using thermal engineering effects provided by a silicon photonics technology.

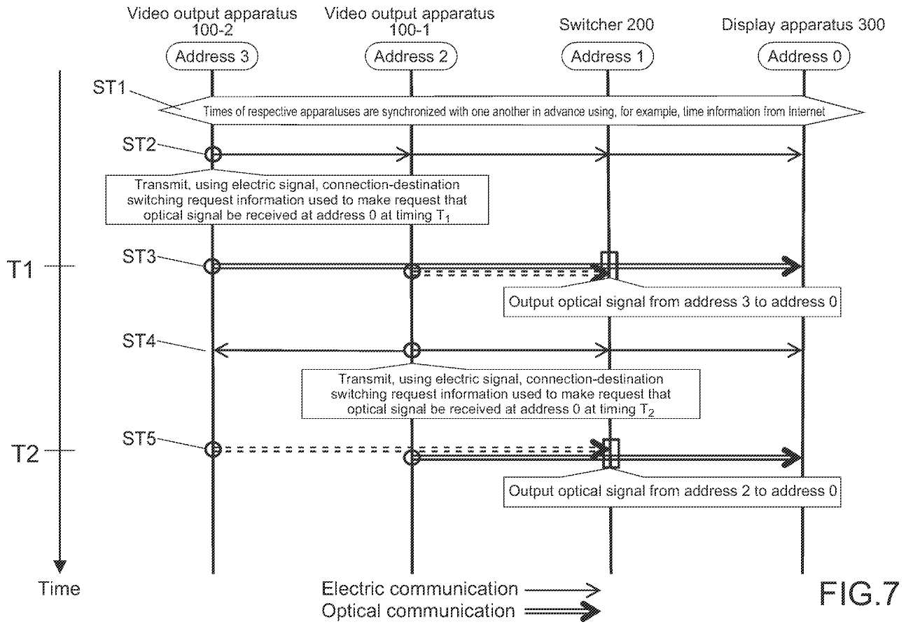

FIG. 7 illustrates an example of a control sequence. In Step ST1, the times of all of the four connected apparatuses are synchronized with one another by, for example, acquiring time information in advance using, for example, an Internet connection. This enables the respective apparatuses to communicate connection-destination switching request information to one another on the basis of the time information in common.

It is assumed that, at a time before a time T1, a user turns on the video output apparatus 100-2 of the address 3, gives an instruction for playback, and tries to view audio and video output from the video output apparatus 100-2, using the display apparatus 300 of the address 0.

In Step ST2, the video output apparatus 100-2 of the address 3 transmits, using an electric signal, connection-destination switching request information used to make a request that an optical signal be received by the display apparatus 300 of the address 0 at the time T1. Here, the time T1 is determined in consideration of, for example, the time necessary for the switcher 200 to perform a switching of input, and the time necessary for the display apparatus 300 to prepare to perform output. The connection-destination switching request information includes, for example, information regarding the address 3 of the connection source, information regarding the address 0 of the connection destination, and information regarding the time T1 that indicates a switching timing.

The switcher 200 of the address 1 acquires the connection-destination switching request information, and, at the time T1 in Step ST3, the switcher 200 performs switching on the optical switch 219 included in the switcher 200, such that the input section IN2 connected to the video output apparatus 100-2 of the address 3 and the output section OUT connected to the display apparatus 300 of the address 0 are connected to each other. Consequently, an optical signal output from the video output apparatus 100-2 of the address 3 is transmitted to the display apparatus 300 through the switcher 200, and this makes it possible to view audio and video output from the video output apparatus 100-2, using the display apparatus 300.

Further, it is assumed that, thereafter, at a time before a time T2, the user turns on the video output apparatus 100-1 of the address 2, gives an instruction for playback, and tries to view audio and video output from the video output apparatus 100-1, using the display apparatus 300 of the address 0.

In Step ST4, the video output apparatus 100-1 of the address 2 transmits, using an electric signal, connection-destination switching request information used to make a request that an optical signal be received by the display apparatus 300 of the address 0 at the time T2. Here, the time T2 is determined in consideration of, for example, the time necessary for the switcher 200 to perform a switching of input, and the time necessary for the display apparatus 300 to perform a switching of output. The connection-destination switching request information includes, for example, information regarding the address 2 of the connection source, information regarding the address 0 of the connection destination, and information regarding the time T2 that indicates a switching timing.

The switcher 200 of the address 1 acquires the connection-destination switching request information, and, at the time T2 in Step ST5, the switcher 200 performs switching on the optical switch 219 included in the switcher 200, such that the input section IN1 connected to the video output apparatus 100-1 of the address 2 and the output section OUT connected to the display apparatus 300 of the address 0 are connected to each other. Consequently, an optical signal output from the video output apparatus 100-1 of the address 2 is transmitted to the display apparatus 300 through the switcher 200, and this makes it possible to view audio and video output from the video output apparatus 100-1, using the display apparatus 300.

Note that, in addition to being transmitted to the switcher 200 of the address 1, as described above, the connection-destination switching request information transmitted in Step ST4 is transmitted to the video output apparatus 100-2 of the address 3 and the display apparatus 300 of the address 0.

The video output apparatus 100-2 of the address 3 can also perform processing using the connection-destination switching request information, such as processing of determining that it is not a problem if an output of the video output apparatus 100-2 is stopped since the output is not effective after the time T2.

Further, before or after the time T2, the display apparatus 300 of the address 0 can also perform processing using the connection-destination switching request information, such as muting processing or cross-fade processing that is performed in response to an apparatus of an input signal being changed at the time T2.

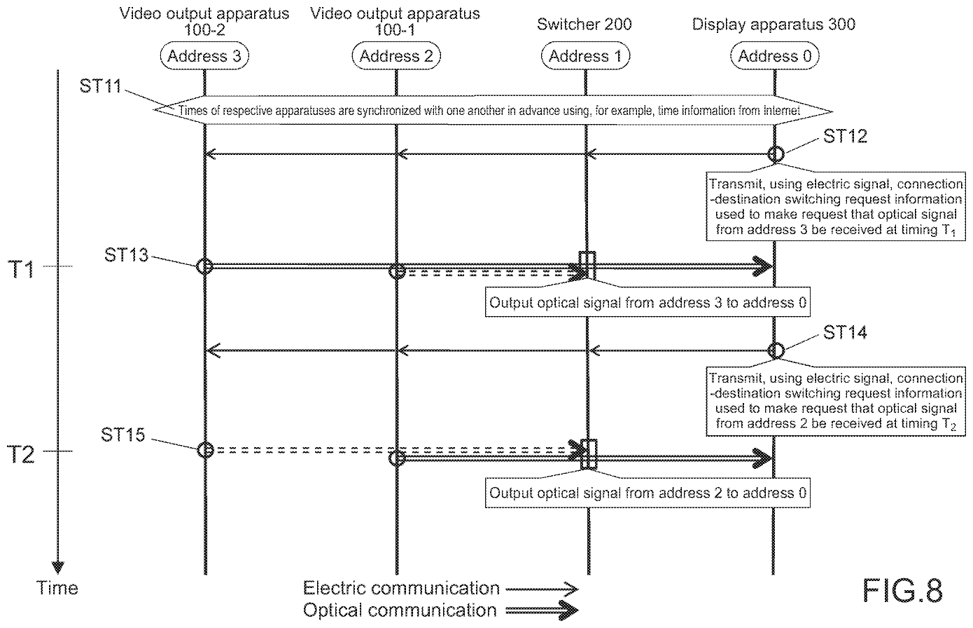

FIG. 8 illustrates another example of the control sequence. In Step ST11, the times of all of the four connected apparatuses are synchronized with one another by, for example, acquiring time information in advance using, for example, an Internet connection. This enables the respective apparatuses to communicate connection-destination switching request information to one another on the basis of the time information in common.

It is assumed that, at a time before a time T1, a user turns on the display apparatus 300 of the address 0, gives an instruction for display, and tries to view audio and video output from the video output apparatus 100-2.

In Step ST12, the display apparatus 300 of the address 0 transmits, using an electric signal, connection-destination switching request information used to make a request that an optical signal from the video output apparatus 100-2 of the address 3 be received at the time T1. Here, the time T1 is determined in consideration of, for example, the time necessary for the switcher 200 to perform a switching of input, and the time necessary for the video output apparatus 100-2 to prepare to perform output. The connection-destination switching request information includes, for example, information regarding the address 0 of the connection source, information regarding the address 3 of the connection destination, and information regarding the time T1 that indicates a switching timing.

The switcher 200 of the address 1 acquires the connection-destination switching request information, and, at the time T1 in Step ST3, the switcher 200 performs switching on the optical switch 219 included in the switcher 200, such that the input section IN2 connected to the video output apparatus 100-2 of the address 3 and the output section OUT connected to the display apparatus 300 of the address 0 are connected to each other. Consequently, an optical signal output from the video output apparatus 100-2 of the address 3 is transmitted to the display apparatus 300 through the switcher 200, and this makes it possible to view audio and video output from the video output apparatus 100-2, using the display apparatus 300.

Note that, in addition to being transmitted to the switcher 200 of the address 1, as described above, the connection-destination switching request information transmitted in Step ST12 is transmitted to the video output apparatus 100-2 of the address 3 and the video output apparatus 100-1 of the address 2.

For example, the video output apparatus 100-2 of the address 3 can perform processing using the connection-destination switching request information, such as preparation processing that enables an output of an optical signal at the time T1.

Further, it is assumed that, thereafter, at a time before a time T2, a user operates the display apparatus 300 of the address 0, and tries to view audio and video output from the video output apparatus 100-2.

In Step ST14, the display apparatus 300 of the address 0 transmits, using an electric signal, connection-destination switching request information used to make a request that an optical signal from the video output apparatus 100-1 of the address 2 be received at the time T2. Here, the time T2 is determined in consideration of, for example, the time necessary for the switcher 200 to perform a switching of input, and the time necessary for the video output apparatus 100-1 to prepare to perform output. The connection-destination switching request information includes, for example, information regarding the address 0 of the connection source, information regarding the address 2 of the connection destination, and information regarding the time T2 that indicates a switching timing.

The switcher 200 of the address 1 acquires the connection-destination switching request information, and, at the time T2 in Step ST15, the switcher 200 performs switching on the optical switch 219 included in the switcher 200, such that the input section IN1 connected to the video output apparatus 100-1 of the address 2 and the output section OUT connected to the display apparatus 300 of the address 0 are connected to each other. Consequently, an optical signal output from the video output apparatus 100-1 of the address 2 is transmitted to the display apparatus 300 through the switcher 200, and this makes it possible to view audio and video output from the video output apparatus 100-1, using the display apparatus 300.

Note that, in addition to being transmitted to the switcher 200 of the address 1, as described above, the connection-destination switching request information transmitted in Step ST4 is transmitted to the video output apparatus 100-2 of the address 3 and the video output apparatus 100-1 of the address 2.

For example, the video output apparatus 100-1 of the address 2 can perform processing using the connection-destination switching request information, such as preparation processing that enables an output of an optical signal at the time T2. Further, the video output apparatus 100-2 of the address 3 can also perform processing using the connection-destination switching request information, such as processing of determining that it is not a problem if an output of the video output apparatus 100-2 is stopped since the output is not effective after the time T2.

As described above, in the communication system 10 illustrated in FIG. 1, connection-destination switching request information regarding an optical signal is output to an electric communication line (the electric wire 412 for an electric communication). This enables the switcher 200 performing a switching of an optical signal to obtain switching information without including a photoelectric conversion circuit. This makes it possible to easily manufacture the switcher 200 at low cost.

Further, in the communication system 10 illustrated in FIG. 1, the connection-destination switching request information includes connection destination information. This makes it possible to switch to any connection destination. Further, in the communication system 10 illustrated in FIG. 1, for example, the connection-destination switching request information includes time information that indicates a switching timing. This makes it possible to switch the connection destination at any timing.

[Difference from Configuration in which High-Speed Signal Line of HDMI According to Present Technology has been Changed to Optical Line]

Here, a difference from a configuration in which a high-speed signal line of High-Definition Multimedia Interface (HDMI) according to the present technology has been changed to an optical line, is described.

When switching is performed using HDMI, switching is performed not only on a video transmission line, but also on all of the signal lines. On the other hand, according to the present technology, address information is added to each piece of information with respect to an electric control signal. Consequently, the electric control signal can be shared by apparatuses connected to one another to be dealt with as a network signal, and thus there is no need to perform switching on all of the electric signals when switching is performed.

Further, switching is performed after time information in common is obtained. This makes it possible to optimally perform, for example, a seamless switching, and a control in order to reduce power consumption.

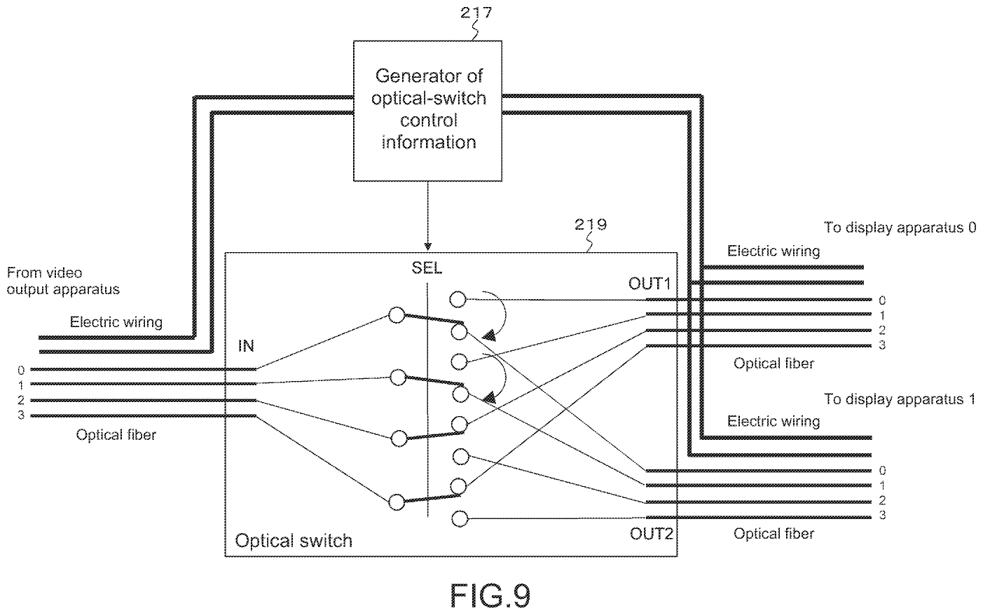

Furthermore, the present technology also makes it possible to perform a more complicated switching control when four independent optical communication channels are included, for example, as illustrated in FIG. 2. The following is an example of the more complicated switching control. As illustrated in FIG. 9, switching is performed at a certain timing, such that a video transmitted using all of the channels up to now is output using a channel 2 and a channel 3, and such that signals from a channel 0 and a channel 1 are output to a different display apparatus. Consequently, a single high-performance video output apparatus can be shared by a plurality of display apparatuses.

### 2. MODIFICATIONS

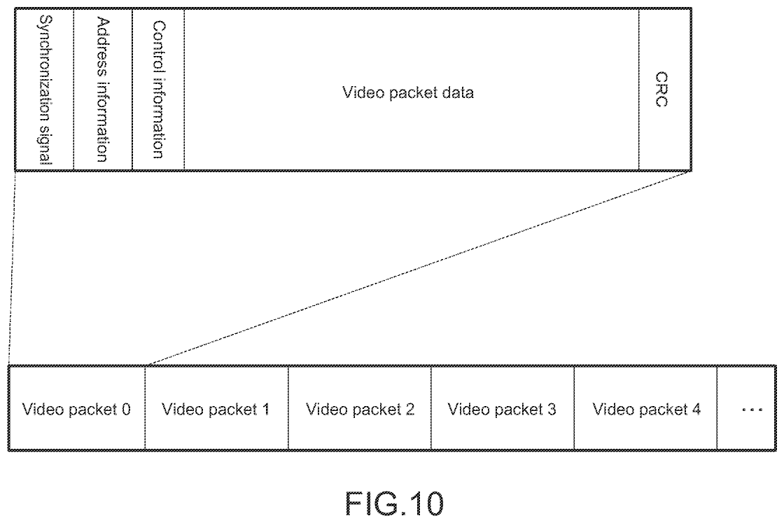

Note that the example in which the video output apparatus performs a video stream output has been described in the embodiments above. However, when, for example, a signal has a packet structure as illustrated in FIG. 10 and an address of a display apparatus is added to a header of each packet, a separate notification of information regarding the address in the form of an electric signal makes it possible to seamlessly switch a packet transmission destination without a photoelectric conversion being performed.

Further, the example in which connection-destination switching request information is transmitted through an electric communication line, has been described in the embodiments above. However, the addition of electric wiring makes it possible to supply power to a facing apparatus, and to determine the attachment or the removal of a connector using an electric signal, in addition to an optical communication being performed using an optical fiber. Further, a low-speed control signal can be more easily transmitted using an electric circuit, compared to when it is transmitted in the form of an optical signal. Thus, for example, additional information regarding a transmission signal, information regarding the transmission-and-reception performance of a connected apparatus, topology information regarding apparatuses connected to each other, a control of an apparatus-to-apparatus cooperative operation, and the like can be independent in the form of an optical signal to be exchanged asynchronously with an optical signal.

The favorable embodiments of the present disclosure have been described above in detail with reference to the accompanying drawings. However, the technical scope of the present disclosure is not limited to these examples. It is clear that persons who have common knowledge in the technical field of the present disclosure could conceive various alterations or modifications within the scope of a technical idea according to an embodiment of the present disclosure. It is understood that of course such alterations or modifications also fall under the technical scope of the present disclosure.

Further, the effects described herein are not limitative, but are merely descriptive or illustrative. In other words, the technology according to the present disclosure may provide other effects apparent to those skilled in the art from the description herein, in addition to, or instead of the effects described above.

Note that the present technology may also take the following configurations.

(1) An information processing apparatus, including:
an optical signal output section that outputs an optical signal to an optical communication line; and
an electric signal output section that outputs connection-destination switching request information regarding the optical communication line to an electric communication line.
   (2) The information processing apparatus according to (1), in which
the connection-destination switching request information includes connection destination information.
   (3) The information processing apparatus according to (1) or (2), in which
the connection-destination switching request information includes time information that indicates a switching timing.
   (4) The information processing apparatus according to any one of (1) to (3), in which
the optical signal output section outputs an optical signal to each of the optical communication lines of a plurality of channels, and
the electric signal output section outputs, to the electric communication line, the connection-destination switching request information regarding the optical communication line of one of the plurality of channels.
   (5) An information processing method, including:
outputting an optical signal to an optical communication line; and
outputting connection-destination switching request information regarding the optical communication line to an electric communication line.
   (6) An information processing apparatus, including:
an optical signal input section to which an optical signal coming from an optical communication line is input; and
an electric signal output section that outputs connection-destination switching request information regarding the optical communication line to an electric communication line.
   (7) The information processing apparatus according to (6), in which
the connection-destination switching request information includes connection destination information.
   (8) The information processing apparatus according to (6) or (7), in which
the connection-destination switching request information includes time information that indicates a switching timing.
   (9) The information processing apparatus according to any one of (6) to (8), in which
an optical signal coming from each of the optical communication lines of a plurality of channels is input to the optical signal input section, and
the electric signal output section outputs, to the electric communication line, the connection-destination switching request information regarding the optical communication line of one of the plurality of channels.
   (10) An information processing method, including:
inputting an optical signal coming from an optical communication line; and
outputting connection-destination switching request information regarding the optical communication line to an electric communication line.
   (11) An information processing apparatus, including:
an optical switch that is situated between optical communication lines of a specified number of systems situated on an input side, and optical communication lines of a specified number of systems situated on an output side; and
a controller that acquires connection-destination switching request information from an electric communication line, and controls, on the basis of the connection-destination switching request information, a connection established, in the optical switch, between the optical communication line on the input side and the optical communication line on the output side.
   (12) The information processing apparatus according to (11), in which
the connection-destination switching request information includes connection destination information.
   (13) The information processing apparatus according to (11) or (12), in which
the connection-destination switching request information includes time information that indicates a switching timing.
   (14) The information processing apparatus according to any one of (11) to (13), in which
on the basis of the connection-destination switching request information, the controller controls a connection established, in the optical switch, between the optical communication line of one of a plurality of channels situated on the input side, and the optical communication line of one of a plurality of channels situated on the output side.
   (15) The information processing apparatus according to any one of (11) to (14), further including
a connection section through which electric communication lines respectively corresponding to the optical communication lines of the specified number of systems situated on the input side, and electric communication lines respectively corresponding to the optical communication lines of the specified number of systems situated on the output side are all mutually connected.
   (16) An information processing method, including:
controlling, on the basis of connection-destination switching request information acquired from an electric communication line, a connection established in an optical switch that is situated between optical communication lines of a specified number of systems situated on an input side, and optical communication lines of a specified number of systems situated on an output side, the connection being established between the optical communication line on the input side and the optical communication line on the output side.
   (17) A communication system, including:
a specified number of output apparatuses;
a specified number of input apparatuses; and
a switcher that is situated between the specified number of output apparatuses and the specified number of input apparatuses, the communication system further including an optical communication line and an electric communication line between each of the specified number of output apparatuses and the switcher, the communication system further including an optical communication line and an electric communication line between each of the specified number of input apparatuses and the switcher, the switcher connecting a specified one of the optical communication lines on an input side to a specified one of the optical communication lines on an output side, on the basis of connection-destination switching request information acquired from the electric communication line.

### REFERENCE SIGNS LIST

10 communication system
21 control motor
22 actuator
23, 27, 28 optical fiber
24, 26, 29 lens
25 total reflection prism
100, 100-1, 100-2 video output apparatus
111 encoder
112 electrical-optical converter
113 optical fiber
114 generator of connection-destination switching request information
115 encoder
116 electric wiring
117 receptacle
200 switcher
211 receptacle
212 optical fiber
213 electric wiring
214 receptacle
215 optical fiber
216 electric wiring
217 generator of optical-switch control information
218 clock section
219 optical switch
220 receptacle
221 optical fiber
222 electric wiring
300 display apparatus
311 receptacle
312 optical fiber
313 photoelectric converter
314 decoder
315 generator of connection-destination switching request
information
316 encoder
317 electric wiring
400, 400-1, 400-2, 400-3 cable
411 optical fiber for optical communication
412 electric wire for electric communication
421 cable portion
422 plug portion
431 optical communication terminal
432 electric communication terminal
433 positioning pin

1. An information processing apparatus, comprising:
an optical signal output section that outputs an optical signal to an optical communication line; and
an electric signal output section that outputs connection-destination switching request information regarding the optical communication line to an electric communication line.

2. The information processing apparatus according to claim 1, wherein
the connection-destination switching request information includes connection destination information.

3. The information processing apparatus according to claim 1, wherein
the connection-destination switching request information includes time information that indicates a switching timing.

4. The information processing apparatus according to claim 1, wherein
the optical signal output section outputs an optical signal to each of the optical communication lines of a plurality of channels, and
the electric signal output section outputs, to the electric communication line, the connection-destination switching request information regarding the optical communication line of one of the plurality of channels.

5. An information processing method, comprising:
outputting an optical signal to an optical communication line; and
outputting connection-destination switching request information regarding the optical communication line to an electric communication line.

6. An information processing apparatus, comprising:
an optical signal input section to which an optical signal coming from an optical communication line is input; and
an electric signal output section that outputs connection-destination switching request information regarding the optical communication line to an electric communication line.

7. The information processing apparatus according to claim 6, wherein
the connection-destination switching request information includes connection destination information.

8. The information processing apparatus according to claim 6, wherein
the connection-destination switching request information includes time information that indicates a switching timing.

9. The information processing apparatus according to claim 6, wherein
an optical signal coming from each of the optical communication lines of a plurality of channels is input to the optical signal input section, and
the electric signal output section outputs, to the electric communication line, the connection-destination switching request information regarding the optical communication line of one of the plurality of channels.

10. An information processing method, comprising:
inputting an optical signal coming from an optical communication line; and
outputting connection-destination switching request information regarding the optical communication line to an electric communication line.

11. An information processing apparatus, comprising:
an optical switch that is situated between optical communication lines of a specified number of systems situated on an input side, and optical communication lines of a specified number of systems situated on an output side; and
a controller that acquires connection-destination switching request information from an electric communication line, and controls, on a basis of the connection-destination switching request information, a connection established, in the optical switch, between the optical communication line on the input side and the optical communication line on the output side.

12. The information processing apparatus according to claim 11, wherein
the connection-destination switching request information includes connection destination information.

13. The information processing apparatus according to claim 11, wherein
the connection-destination switching request information includes time information that indicates a switching timing.

14. The information processing apparatus according to claim 11, wherein
on the basis of the connection-destination switching request information, the controller controls a connection established, in the optical switch, between the optical communication line of one of a plurality of channels situated on the input side, and the optical communication line of one of a plurality of channels situated on the output side.

15. The information processing apparatus according to claim 11, further comprising
a connection section through which electric communication lines respectively corresponding to the optical communication lines of the specified number of systems situated on the input side, and electric communication lines respectively corresponding to the optical communication lines of the specified number of systems situated on the output side are all mutually connected.

16. An information processing method, comprising:
controlling, on a basis of connection-destination switching request information acquired from an electric communication line, a connection established in an optical switch that is situated between optical communication lines of a specified number of systems situated on an input side, and optical communication lines of a specified number of systems situated on an output side, the connection being established between the optical communication line on the input side and the optical communication line on the output side.

17. A communication system, comprising:
a specified number of output apparatuses;
a specified number of input apparatuses; and
a switcher that is situated between the specified number of output apparatuses and the specified number of input apparatuses, the communication system further comprising an optical communication line and an electric communication line between each of the specified number of output apparatuses and the switcher, the communication system further comprising an optical communication line and an electric communication line between each of the specified number of input apparatuses and the switcher, the switcher connecting a specified one of the optical communication lines on an input side to a specified one of the optical communication lines on an output side, on a basis of connection-destination switching request information acquired from the electric communication line.
